(19) United States
(12) Patent Application Publication
(10) Pub. No.: US 2004/0166289 A1
(43) Pub. Date: Aug. 26, 2004

(54) Bottom line toilet seat liners

(76) Inventor: Sandra D. Troutman, Southfield, MI (US)

Correspondence Address: Sandra D. Troutman, Suite 701, 5000 Town Center, Southfield, MI, 48075, US

(21) Appl. No.: 10/369,275

(22) Filed: Feb. 20, 2003

(51) Int. Cl. B32B 3/02

(52) U.S. Cl. 428/157

(57) ABSTRACT

The present invention relates to toilet seat liner that consumers can purchase at a retail outlet. The toilet seat liners are developed to provide consumers a layer of protection while using toilets in any environment, especially public restrooms. This invention is to be disposed in a wastebasket and is not intended to be a flushable structure.

The toilet seat liners are individually wrapped and can be placed on top of any standard toilet seat. The seat liners are made with elastic ridges that allow for easy stretching over most toilet seats and a cotton-like fabric at the top for added comfort.

### FIELD OF THE INVENTION

This invention relates to a disposable toilet seat liner. In particular, the invention relates to a toilet seat liner that can be placed on a standard toilet seat in public restrooms or any other situation in which a person finds him/herself using a foreign toilet (located in an environment outside of their personal home). This invention can be placed directly on a toilet seat and easily removed and discarded after each use without the need for carrying equipment or gadgets to mount a portable toilet seat.

### BACKGROUND OF INVENTION

Protection from germs using public restrooms is a desirable attribute for many consumers. Splattering of fluids on the toilet area leaves in a unpleasant and unsanitary condition; therefore, such said invention provides a level of peace of mind to consumers by creating a barrier of protection between their skin and the standard toilet seat. This product is not intended to be used on such as diapers or feminine hygiene products such as sanitary napkins; but rather is used for the purpose of applying the product on the toilet seat before each use and disposed after each use.

It is therefore an object of this invention to provide a disposable toilet seat liner to protect consumers from contact with each other's bodily fluids by using this disposable toilet seat liner. In many instances, paper seat liners are provided in public restrooms; however, these liners tend to be weak and therefore tear if a large amount of bodily fluids is exposed to it. In most cases, public restrooms do not provide consumers with adequate safeguards in using the facility and therefore leaves the ownness on the part of the individual to take matters into their own hands, such as taking a bent over position over the toilet, bringing their own paper products, or folding a large amount of toilet paper over the toilet seat before each use.

Today public restrooms are known as incubators for germs. The use of this invention would help protect consumers from germs and the embarrassment of creating a makeshift seat cover when the existing one is soiled. There is a definite need for this invention for those individuals who do an extensive amount of traveling and those individuals who desire a new approach to using the toilet in public restrooms.

### SUMMARY OF INVENTION

This present invention is directed towards a disposable toilet seat liner which can be discretely carried in an individually wrapped plastic pouch, covers the existing toilet seat, and provides a layer of protection between an individual's skin and the toilet seat against other person's bodily fluids. Each toilet seat liner covers the total parameter of a standard toilet seat. This invention can be used by everyone including children, adults, and senior citizens. An individual would simply take the toilet seat liner out of the bag and apply it to the toilet seat, allowing for the elastics to take hold of the entire seat.

This invention has two major parts: First, the toilet seat liner. This liner will be available to fit most standard existing toilet seats and serve as a thin top cover. The method of operation would include an individual opening an individually wrapped liner bag and unfold the toilet seat liner and placed it over (around) the toilet seat. The toilet seat liner would have elastic ridges around the edge of the outer and inner parameter to comfortably fit standard toilet seats. The elastic would make this an easy fit around any existing toilet seat. Today, the only embodiment of a similar product is the paper-based seat cover, which does not stay in place nor does it provide an unbreakable barrier between the toilet seat and the individual.

Second, the individual liner wrapper bag. These individual bags are used as carrying pouches for the toilet seat liners. Similar to the bags used in wrapping sanitary napkins, these individual liner wrapper bags are thin plastic-like bags are 5 inches in width and approximately 3.75 inches long. A strip of adhesive will hold each bag closed until it is unsealed for use.

### DETAILED DESCRIPTION OF THE INVENTION

The various aspects and embodiments of the invention will be described in the context of disposable toilet seat liner, such as a disposable seat cover or traditional seat cover. It is, however, readily apparent that the present invention could also be employed in conjunction with a traditional toilet seat. Typically, the disposable toilet seat liner is intended for limited use and is not intended to be laundered or otherwise cleaned for reuse. A disposable sanitary napkin, for example, is discarded after the wearer has soil it.

To provide improved fit, the toilet seat liner is outfitted with elastic on the outer and inner ridges spanning the entire circumference of the seat liner. The edged elastics are configured to appropriately gather and shirr the end margins to provide a resilient, comfortable close fit around the toilet cover for the user. To help reduce bodily contact with the standard toilet seat, the bottom of the toilet seat liner is reinforced with a plastic material and the top of the toilet seat liner is covered with a cotton like fiber which adds a layer of comfort to the person during use.

The invention is self-contained in that it the entire invention is a liner that is placed on a standard toilet seat and disposed of after each use. The toilet seat liner wrapper is also self-contained in that it is a portable plastic bag that can be disposed of in the trash once the liner is removed.

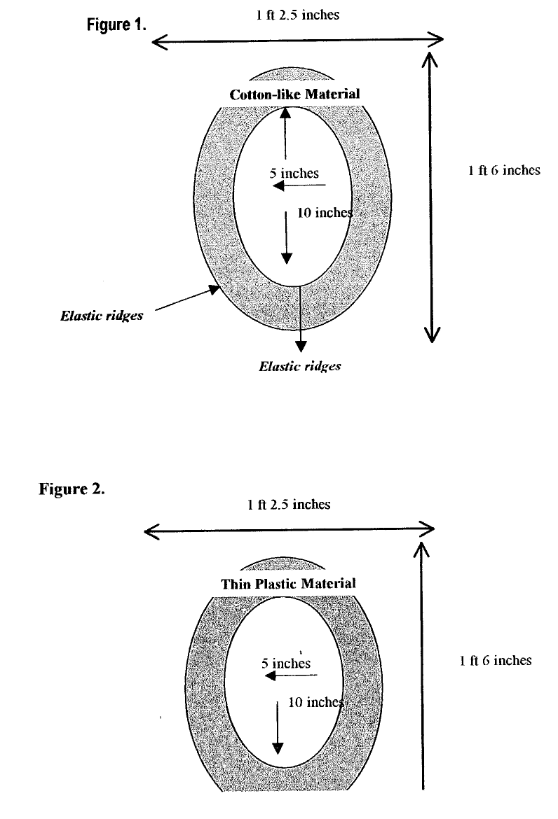

FIG. 1 is a front perspective view of the toilet seat liner showing my design

FIG. 2 is a rear perspective view thereof of FIG. 1

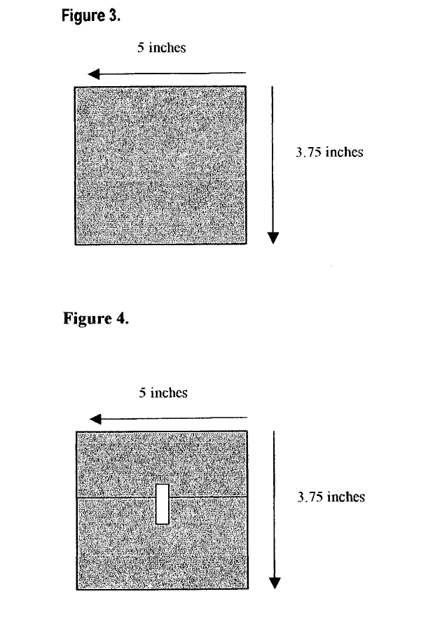

FIG. 3 is a front perspective view of the individual toilet liner wrapper

FIG. 4 is a rear perspective view thereof of FIG. 3

What is claimed is:

1. A toilet seat liner comprising:
A thin lightweight plastic bottom layer said plastic bottom surface for the disposable toilet seat liner. This will allow for a barrier core that locks in moisture for extra protection against contamination.
An elastic ridge going around the entire outer parameter of the toilet seat liner approximately 1 ft 2.5 inches width and 1 ft 6 inches long as seen in FIG. 1
An elastic ridge in the center approximately 5 inches width and 10 inches long as seen in FIG. 1
A thin lightweight cotton-like (micro-fiber) layer said top surface for the disposable toilet seat liner

2. A toilet seat liner as recited in claim 1 wherein said is disposable after each use by removing the said toilet seat liner from the existing toilet seat.

3. An Individual Liner Wrapper Bag as recited in claim 1 wherein said toilet seat liner comprises soft lightweight plastic cover.
